(19) United States
(12) Patent Application Publication
(10) Pub. No.: US 2013/0165045 A1
(43) Pub. Date: Jun. 27, 2013

(54) ELECTRONIC DEVICE AND METHOD FOR SHARING RESOURCES VIA BLUETOOTH NETWORK

(71) Applicant: XIANG CAO, Shenzhen City (CN)

(72) Inventor: XIANG CAO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/479,305

(22) Filed: May 24, 2012

(30) Foreign Application Priority Data
Dec. 26, 2011 (CN) 201110440803.5

(51) Int. Cl. H04W 84/12

(52) U.S. Cl. 455/41.2

(57) ABSTRACT

An electronic device capable of sharing resources with another electronic device via a BLUETOOTH network includes a motion sensor, a BLUETOOTH unit, and a control unit. The motion sensor detects a motion of the electronic device. The control unit determines a trajectory of the motion of the electronic device according to data from the motion sensor, and determines whether the trajectory as determined matches a predefined trajectory. If the trajectory as determined matches a predefined trajectory, the control unit creates a sharing process in relation to at least one application currently running on the electronic device and any object being opened by the application, and sends the created sharing content to another electronic device via the BLUETOOTH unit.

### BACKGROUND

1. Technical Field

The present disclosure relates to electronic devices and, more particularly, to an electronic device and a method capable of sharing resources via a BLUETOOTH network.

2. Description of Related Art

BLUETOOTH is a wireless interface specification for wirelessly connecting portable terminals such as mobile phones, portable personal computers, and other peripheral devices located within a predefined range. Portable terminals employing the BLUETOOTH module can transfer and receive data using the BLUETOOTH communication protocol.

However, it is well-known that the data sharing procedures between the portable terminals via a BLUETOOTH network may be limited, and cumbersome and time consuming to set up. For example, when a first portable terminal wishes to share resources with a second portable terminal, users of the first portable terminal are required to select the resource they wish to share, such as a multimedia file, such that the selected resource can be transmitted to the second portable terminal

Therefore, what is needed is an electronic device that can offer a more efficient, user-friendly procedure for sharing resources via a BLUETOOTH network.

### BRIEF DESCRIPTION OF THE DRAWINGS

Many aspects of the present disclosure can be better understood with reference to the following drawings. The units in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a first electronic device, in accordance with an embodiment.

FIG. 2 is a block diagram of a second electronic device, in accordance with an embodiment.

FIG. 3 is a flowchart of a method of sharing resources via a BLUETOOTH network between the first and the second electronic devices of FIGS. 1 and 2, in accordance with an embodiment.

FIG. 4 is a flowchart of a method of creating and transmitting a sharing content to other electronic device via a BLUETOOTH network, applied to the first electronic device of FIG. 1, in accordance with an embodiment.

FIG. 5 is a flowchart of a method of receiving a sharing content from other electronic device via a BLUETOOTH network, applied to the second electronic device of FIG. 1, in accordance with an embodiment.

### DETAILED DESCRIPTION

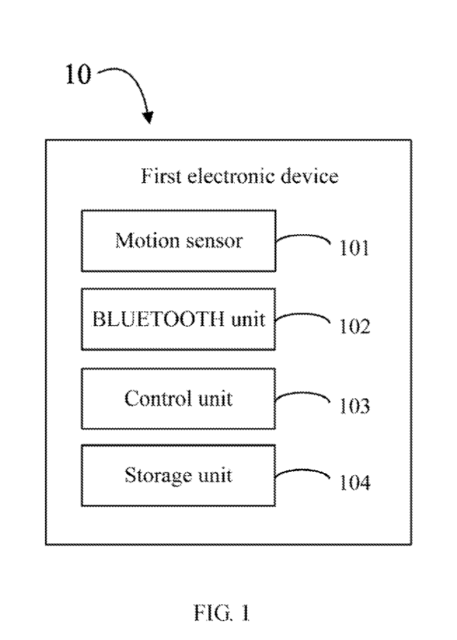

FIG. 1 is a block diagram of a first electronic device 10 capable of sharing resources via a BLUETOOTH network, according to an exemplary embodiment. The first electronic device 10 may be a tablet computer, a media player, or a mobile phone. A shared resource may be an address of a website or at least one multimedia file, such as a graphic file, a video file, or an audio file. In the embodiment, the first electronic device 10 includes a motion sensor 101, a wireless connection unit, such as a BLUETOOTH unit 102 in one embodiment, and a control unit 103.

The motion sensor 101 detects any motion of the first electronic device 10, and sends the motion data to the control unit 103. The control unit 103 determines a trajectory of the movement of the first electronic device 10 according to the motion data. The trajectory of the first electronic device 10 as determined may be a straight line, a curved line, a circle, or the shape of an S. In the embodiment, the motion sensor 101 is a three-axis gyroscope capable of sensing any movement along the X, Y, and Z axis of the first electronic device 10, and the control unit 103 can determine the trajectory of the first electronic device 10 in three dimensions according to the acceleration and motion data of the first electronic device 10. Such a determination/estimation of trajectory is known in the art, such as the subject matter of US Patent Application Publication No. 2007/0171202, which is herein incorporated by reference.

The control unit 103 can further determine whether the trajectory of the first electronic device 10 matches a predefined trajectory. If it does, the control unit 103 creates a sharing process in relation to at least one application currently running on the first electronic device 10 and an object opened by the application, and then transmits the content subject of the object by the sharing process which has been created (created sharing content) to other electronic devices via the BLUETOOTH unit 102. The content subject matter may include the name of the object, part or all of the object, or relevant contents of the object. In one embodiment, the electronic devices which receive the created sharing content can run the same application(s) and then open the same object(s) once the created sharing content is received. In an alternative embodiment, the electronic devices may instead store the created sharing content in the electronic devices through a predetermined storage path once the created sharing content is received to allow users of the electronic device to open the object when needed.

In the embodiment, the created sharing content includes the application name of a currently running application and the name of the object opened by the application. For example, if an internet browser is the currently running application, the control unit 103 determines the address of a website being visited by the internet browser, as whole or part of the content subject matter of the object, and then transmits the created sharing content including the name of the internet browser program and the address of the website being visited to other electronic devices via the BLUETOOTH unit 102, thereby the users of other electronic devices can browse the same web page. If the currently running application is a multimedia player, the control unit 103 determines the multimedia file being played by the multimedia player, as whole or part of the content subject matter of the object, and then transmits the created sharing content including the name of the multimedia player and the name of the multimedia file being played back to other electronic devices via the BLUETOOTH unit 102, thereby allowing the other electronic devices to play and visibly/audibly output the same multimedia file. It is noteworthy that when the other electronic devices are the same as the first electronic device 10, the other electronic devices may have the same factory-provided applications most commonly used and may be able to run the same application(s) and open the same object(s) required for the sharing content once the sharing content is received. Alternatively, the same applications may be those same applications installed by the users of the first electronic device 10 and the users of the second electronic devices 20.

In an alternative embodiment, the sharing content may include the object opened by the currently running application. For example, if a video file is currently played by a multimedia player, the control unit 103 transmits the sharing content including the video file to other electronic devices via the BLUETOOTH unit 102.

In the embodiment, the first electronic device 10 further includes a storage unit 104. The storage unit 104 stores a variety of predefined trajectories and pairing passkeys associated with the predefined trajectories. After determining the trajectory of the first electronic device 10 according to the motion data received from the motion sensor 101, the control unit 103 further determines whether the trajectory as determined corresponds to a pairing passkey. If it does, the trajectory as determined is a predefined trajectory, and the control unit 103 controls the BLUETOOTH unit 102 to search for other electronic devices with BLUETOOTH within an effective range. When at least one second electronic device 20 is found, the control unit 103 sends a connection request to the second electronic device 20 to ask for a connection with the second electronic device 20, and then sends the paring passkey associated with the trajectory as determined to the second electronic device 20.

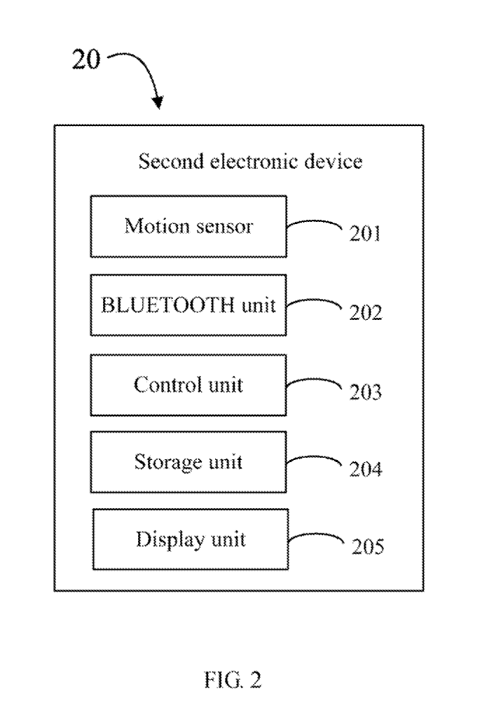

Referring to FIG. 2, in the embodiment, the second electronic device 20 has the same features as the first electronic device 10. Specifically, the second electronic device 20 includes a motion sensor 201, a wireless connection unit, such as a BLUETOOTH unit 202 in one embodiment, and a control unit 203. The motion sensor 201 detects any motion of the second electronic device 20, and sends the motion data to the control unit 203. In an embodiment, the user of the first electronic device 10 is within sight of the user of the second electronic device 20, thus the user of the second electronic device 20 can see the movement of the first electronic device 10 performed by the user. After a connection request has been received by the second electronic device 20, the user of the second electronic device 20 performs a same or similar movement on the second electronic device 20. The control unit 203 determines a trajectory of the movement of the second electronic device 20 according to the motion data, and determines whether the trajectory of the second electronic device 20 as determined matches a predefined trajectory. If it does, the control unit 203 compares a pairing passkey associated with the predefined trajectory of the second electronic device 20 with that transmitted from the first electronic device 10.

In the embodiment, the second electronic device 20 includes a storage unit 204. The storage unit 204 stores a variety of predefined trajectories and associated pairing passkeys, and the association between the trajectories and the pairing passkeys stored in the second electronic device 20 corresponds with that stored in the first electronic device 10. After determining a trajectory of the second electronic device 20 according to the motion data from the motion sensor 201, the control unit 203 further determines whether the trajectory as determined corresponds to a pairing passkey. If it does, the control unit 203 of the second electronic device 20 obtains the pairing passkey corresponding to the trajectory as determined, and compares the pairing passkey with that transmitted from the first electronic device 10. In the embodiment, each of the pairing passkeys associated with the trajectories of the first and the second electronic devices 10, 20 can be, for example, a pre-determined character for a specific shape of a trajectory the users makes. For example, if the trajectory of the second electronic device 20 is determined to be S-shaped, the control unit 203 determines or locates from the stored predefined trajectories and associated pairing passkeys that the pairing passkey associated with the S-shaped trajectory is “S”.

Therefore, when attempting to share resources between the first and the second electronic devices 10, 20, for example, from the first electronic device 10 to the second electronic device 20, the first electronic device 10 is first moved along a predefined trajectory. In addition to creating the sharing process for a particular application and content, the control unit 103 of the first electronic device 10 also sends a connection request and a pairing passkey associated with the predefined trajectory to the second electronic device 20. The second electronic device 20 is then moved along a trajectory same as or similar to the trajectory of the first electronic device 10, and then the control unit 203 of the second electronic device 20 compares the pairing passkey associated with the trajectory of the second electronic device 20 with that transmitted from the first electronic device 10. If the pairing passkeys match, the first and the second electronic devices 10, 20 establish a connection, and the control unit 103 sends the created sharing content via the BLUETOOTH unit 103 to the second electronic device 20. Thus, users can share resources between the first and the second electronic devices 10, 20 simply by waving their respective electronic devices in the air.

In the embodiment, when the second electronic device 20 receives the sharing content transmitted from the first electronic device 10, the control unit 203 controls the second electronic device 20 to run the same application(s) required for the received content and controls the application(s) to open the same objects(s). In the embodiment, the second electronic device 20 further includes a display unit 205, when the control unit 203 determines that the second electronic device 20 does not have the same application(s) required for the sharing content, the control unit 203 generates an error or similar warning and controls the display unit 205 to display the warning.

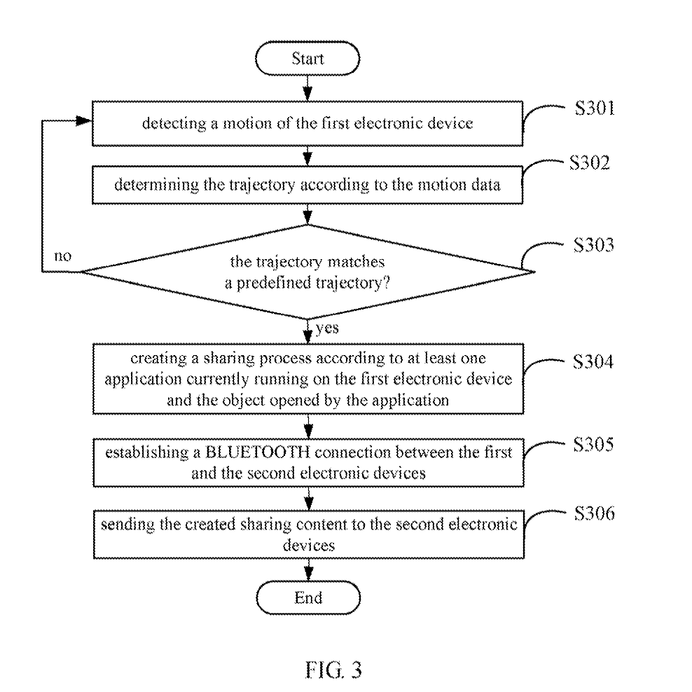

FIG. 3 is a flowchart of a method of sharing resources via a BLUETOOTH network between the first and the second electronic devices 10 and 20 according to an exemplary embodiment.

In step S301, the motion sensor 101 of the first electronic device 10 detects a motion of the first electronic device 10.

In step S302, the control unit 103 of the first electronic device 10 determines the trajectory of the movement of the first electronic device 10 according to the motion data from the motion sensor 101.

In step S303, the control unit 103 determines whether the trajectory of the first electronic device 10 matches a predefined trajectory; if yes, then the procedure goes to step S304, otherwise, the procedure goes back to step S301.

In step S304, the control unit 103 creates the sharing process in relation to at least one application currently running on the first electronic device and any object opened by the application.

In step S305, a BLUETOOTH connection is established between the first and the second electronic devices 10, 20.

In step S306, the control module 103 sends the created sharing content to the second electronic devices 20 via the BLUETOOTH unit 102.

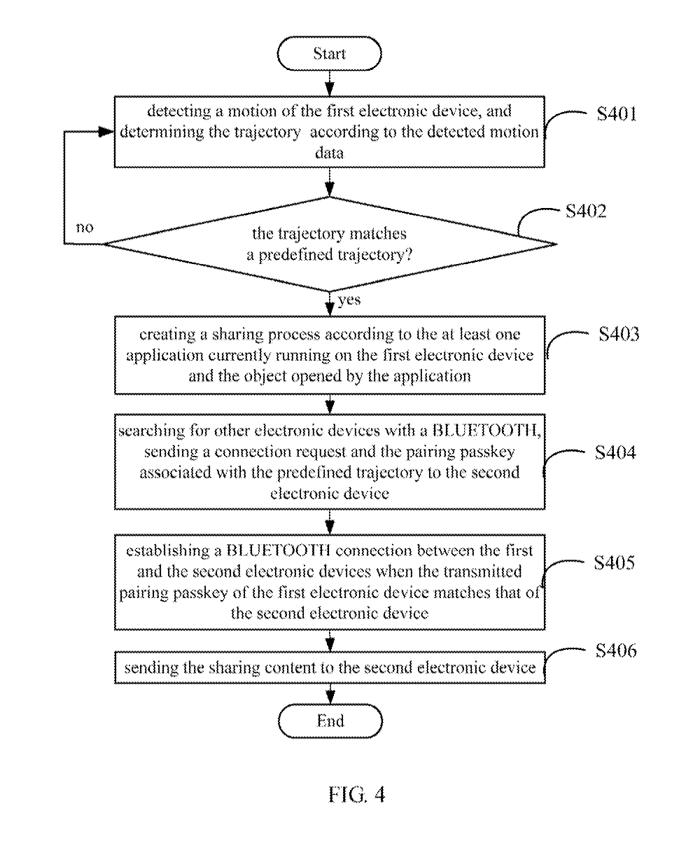

FIG. 4 is a flowchart of a method of creating and transmitting a sharing content to other electronic device a BLUETOOTH network implemented by the first electronic device 10 of FIG. 1 according to an exemplary embodiment.

In step S401, the motion sensor 101 detects a motion of the first electronic device 10, and the control unit 103 determines the trajectory of the movement of the first electronic device 10 according to the motion data from the motion sensor 101.

In step S402, the control unit 103 determines whether the trajectory as determined of the first electronic device 10 matches a predefined trajectory; if yes, the procedure goes to step S403, otherwise the procedure goes back to step S401.

In step S403, the control unit 103 creates a sharing process in relation to the at least one application currently running on the first electronic device 10 and any object opened by the application.

In step S404, the control unit 103 controls the BLUETOOTH unit 102 to search for other electronic devices with BLUETOOTH within an effective range, when at least one second electronic device 20 is found, the control unit 103 sends a connection request to the second electronic device 20 to ask for a connection with the second electronic device 20, and then transmits the pairing passkey associated with the trajectory as determined to the second electronic device 20.

In step S405, a BLUETOOTH connection is established between the first and the second electronic devices 10, 20 when the transmitted pairing passkey of the first electronic device 10 matches that of the second electronic device 20.

In step S406, the control unit 101 sends the created sharing content to the second electronic devices 20 via the BLUETOOTH unit 102.

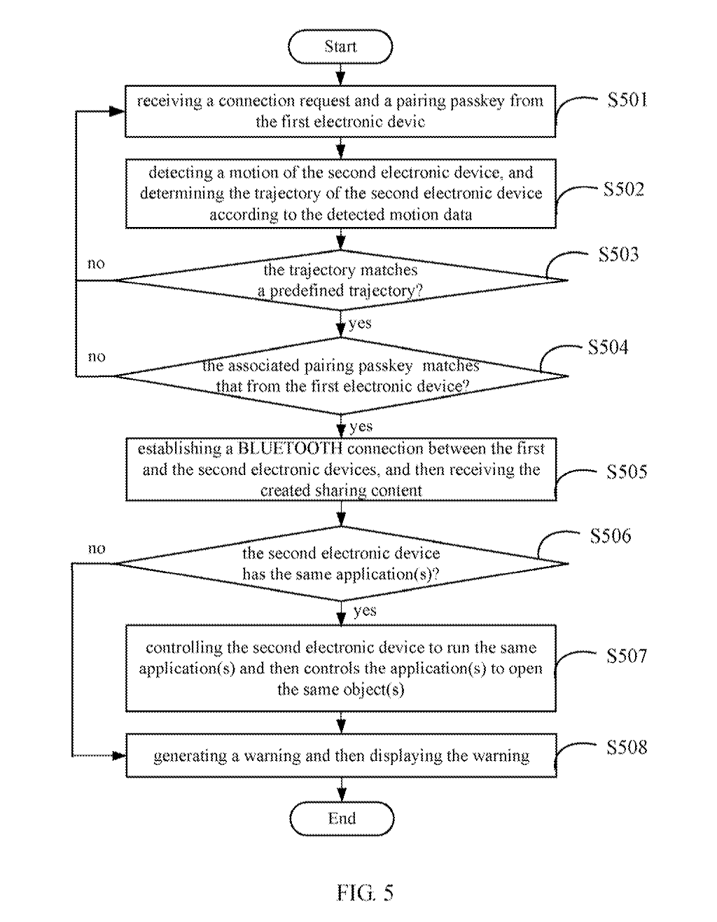

FIG. 5 is a flowchart of a method of receiving a sharing content from other electronic device via a BLUETOOTH network implemented by the second electronic device 20 of FIG. 2 according to an exemplary embodiment.

In step S501, the BLUETOOTH unit 202 receives a connection request and a pairing passkey from the first electronic device 10.

In step S501, the motion sensor 201 of the second electronic device 20 detects a motion of the second electronic device 20 after receiving a connection request from the first electronic device 10, and the control unit 203 determines the trajectory of the movement of the second electronic device 20 according to the motion data from the motion sensor 201.

In step S503, the control unit 203 determines whether the trajectory as determined of the second electronic device 20 matches a predefined trajectory; if yes, the procedure goes to step S504, otherwise the procedure goes back to step S501.

In step S504, the control unit 203 compares the pairing passkey associated with the trajectory of the second electronic device 20 as determined with that transmitted from the first electronic device 10; if the pairing passkey of the second electronic device 20 matches that from the first electronic device 10, then the procedure goes to step S505, otherwise, the procedure goes to step S501.

In step S505, the control unit 203 establishes a BLUETOOTH connection between the first and the second electronic devices 10, 20, and then controls the second electronic device 20 to receive the created sharing content.

In step S506, the control unit 203 determines whether the second electronic device 20 has the same application(s) required for the created sharing content; if yes, the procedure goes to step S507, otherwise, the procedure goes to step S508.

In step S507, the control unit 203 controls the second electronic device 20 to run the application(s) as required and then controls the application(s) to open the same object(s).

In step S508, the control unit 203 generates a warning of error and then controls the display unit 205 to display the warning.

Although the present disclosure has been described in accordance with the embodiments shown, one of ordinary skill in the art will readily recognize that there could be variations to the embodiments and those variations would be within the spirit and scope of the present disclosure. Accordingly, many modifications may be made by one of ordinary skill in the art without departing from the spirit and scope of the appended claims.

What is claimed is:

1. An electronic device capable of sharing resources with another electronic device via a BLUETOOTH network, the electronic device comprising:
a motion sensor to detect a motion of the electronic device;
a BLUETOOTH unit; and
a control unit configured to:
determine a trajectory of the electronic device according to data from the motion sensor;
determine whether the trajectory as determined matches a predefined trajectory;
create a sharing content according to at least one application currently running on the electronic device and any object opened by the application if the trajectory as determined matches with a predefined trajectory, and
send the created sharing content to another electronic devices via the BLUETOOTH unit.

2. The electronic device as described in claim 1, wherein the created sharing content comprises an application name of the currently running application and a name of the object opened by the application.

3. The electronic device as described in claim 2, wherein if the control unit determines that an internet browser is the currently running application, the control unit further determines an address of the website being visited by the internet browser, and then sends the sharing content comprising a name of the internet browser program and the address of the website being visited to other electronic devices via the BLUETOOTH unit.

4. The electronic device as described in claim 2, wherein if the control unit determines that a multimedia player is the currently running application, the control unit further determines a multimedia file being played by the multimedia player, and then sends the sharing content comprising a name of the multimedia player and a name of the multimedia file being played to other electronic devices via the BLUETOOTH unit.

5. The electronic device as described in claim 1, wherein the created sharing content comprises the object opened by the currently running application.

6. The electronic device as described in claim 5, wherein if the control unit determines that a multimedia player is the currently running application, the control unit determines a multimedia file being played by the multimedia player, and sends the sharing content comprising the multimedia file being played to other electronic devices via the wireless connection unit.

7. The electronic device as described in claim 1, further comprising a storage unit, wherein the storage unit stores a plurality of predefined trajectories of the electronic device and pairing passkeys associated with the predefined trajectories, and the control unit further determines whether the trajectory as determined corresponds to a pairing passkey after determining the trajectory of the electronic device, and determines that the trajectory as determined is a predefined trajectory if the trajectory corresponds to a pairing passkey.

8. The electronic device as described in claim 7, wherein the control unit further controls the BLUETOOTH unit to search for other electronic devices having a BLUETOOTH unit if the determined trajectory corresponds to a pairing passkey, and transmits a connection request to the found electronic device to ask for a connection, and transmits a pairing passkey associated with the trajectory as determined to the found electronic device, and when a BLUETOOTH connection has been established, the control unit transmits the created sharing content via the BLUETOOTH unit of the electronic device to the found electronic device.

9. The electronic device as described in claim 7, wherein the control unit is further configured to, upon receiving a BLUETOOTH connection request, determine whether a trajectory of the electronic device matches one of the predefined trajectories, and if match is found, locate a pairing passkey associated with the determined trajectory and use the paring passkey to respond to the connection request for establishing a BLUETOOTH connection.

10. An electronic device capable of sharing resources with another electronic device via a wireless network, the electronic device comprising:
a motion sensor to detect a motion of the electronic device;
a wireless connection unit; and
a control unit configured to:
determine a trajectory of the electronic device according to data from the motion sensor;
determine whether the trajectory as determined matches a predefined trajectory;
create a sharing content according to at least one application currently running on the electronic device and any object opened by the application if the trajectory as determined matches with a predefined trajectory, and
send the created sharing content to other electronic devices via the wireless connection unit.

11. The electronic device as described in claim 10, wherein the created sharing content comprises an application name of the currently running application and a name of the object opened by the application.

12. The electronic device as described in claim 11, wherein if the control unit determines that an internet browser is the currently running application, the control unit further determines an address of the website being visited by the internet browser, and then sends the sharing content comprising a name of the internet browser program and the address of the website being visited to other electronic devices via the wireless connection unit.

13. The electronic device as described in claim 11, wherein if the control unit determines that a multimedia player is the currently running application, the control unit further determines a multimedia file being played by the multimedia player, and then sends the sharing content comprising a name of the multimedia player and a name of the multimedia file being played to other electronic devices via the wireless connection unit.

14. The electronic device as described in claim 10, wherein the created sharing content comprises the object opened by the currently running application.

15. The electronic device as described in claim 14, wherein if the control unit determines that a multimedia player is the currently running application, the control unit determines a multimedia file being played by the multimedia player, and sends the sharing content comprising the multimedia file being played to other electronic devices via the wireless connection unit.

16. The electronic device as described in claim 10, further comprising a storage unit, wherein the storage unit stores a plurality of predefined trajectories of the electronic device and pairing passkeys associated with the predefined trajectories, and the control unit further determines whether the trajectory as determined corresponds to a pairing passkey after determining the trajectory of the electronic device, and determines that the trajectory as determined is a predefined trajectory if the trajectory corresponds to a pairing passkey.

17. The electronic device as described in claim 16, wherein the control unit further controls the wireless connection unit to search for other electronic devices having a wireless connection unit if the determined trajectory corresponds to a pairing passkey, and transmits a connection request to the found electronic device to ask for a connection, and transmits a pairing passkey associated with the trajectory as determined to the found electronic device, and a wireless connection has been established, the control unit transmits the created sharing content via the wireless connection unit of the electronic device to the found electronic device.

18. The electronic device as described in claim 16, wherein the control unit is further configured to, upon receiving a wireless connection request, determine whether a trajectory of the electronic device matches one of the predefined trajectories, and if match is found, locate a pairing passkey associated with the determined trajectory and use the paring passkey to respond to the connection request for establishing a wireless connection.

19. A method for sharing resources via a wireless network between a first electronic device and a second electronic device, the method comprising:
detecting a motion of the first electronic device to obtain motion data;
determining a first trajectory of the first electronic device according to the motion data;
determining whether the first trajectory as determined matches a predefined trajectory;
creating a sharing content according to at least one application currently running on the first electronic device and any object opened by the application if the first trajectory as determined matches a predefined trajectory;
establishing a wireless connection between the first and the second electronic devices; and
sending the created sharing content to the second electronic device.

20. The method as described in claim 19, wherein the created sharing content comprises an application name of the currently running application and a name of the object opened by the application.

21. The method as described in claim 19, wherein the created sharing content comprises the object opened by the currently running application.

22. The method as described in claim 20, wherein if an internet browser is the currently running application, the sharing content comprises a name of the internet browser program and an address of the website being visited by the internet browser.

23. The method as described in claim 20, wherein if a multimedia player is the currently running application, the sharing content comprises a name of the multimedia player and a name of the multimedia file being played by the multimedia player.

24. The method as described in claim 19, wherein the step of “establishing a wireless connection between the first and the second electronic devices” comprises:
determining a first pairing passkey associated with the first trajectory;
sending a connection request and the first pairing passkey to the second electronic device;
creating a second trajectory of the second electronic device corresponding to the first trajectory, after receiving the wireless connection request from the first electronic device;
determining a second pairing passkey associated with the second trajectory; and
using the second pairing passkey to pair with the first pairing passkey to establish a wireless connection between the first and the second electronic devices.
